(19) United States
(12) Patent Application Publication
(10) Pub. No.: US 2016/0173906 A1
(43) Pub. Date: Jun. 16, 2016

(54) PARTITION MODE AND TRANSFORM SIZE DETERMINATION BASED ON FLATNESS OF VIDEO

(71) Applicant: Intel Corporation, Santa Clara, CA (US)

(72) Inventors: ZHIJUN LEI, Portland, OR (US); JASON TANNER, Folsom, CA (US)

(21) Appl. No.: 14/567,162

(22) Filed: Dec. 11, 2014

(51) Int. Cl. H04N 19/593; H04N 19/167; H04N 19/96; H04N 19/52; H04N 19/51; H04N 19/61

(52) U.S. Cl. CPC H04N 19/593; H04N 19/51; H04N 19/61; H04N 19/96; H04N 19/52; H04N 19/167

(57) ABSTRACT

Techniques related to determining partition modes and transform sizes for video coding are discussed. Such techniques may include determining a portion of a video frame is flat and bypassing an inter-prediction partition check and/or a transform size check for the portion of the video frame based on the portion of the video frame being flat.

### BACKGROUND

A video encoder compresses video information so that more information can be sent over a given bandwidth or saved in a given file size. The compressed signal or file may be transmitted to a receiver or video decoder that may decode or decompress the signal or file for display to a user. Such video encoder-decoder systems may follow a format or standard. For example, video compression standards include the H.264/MPEG-4 Advanced Video Coding (AVC) standard, the High Efficiency Video Coding (HEVC) standard, and the VP9 standard. Such standards may include basic functional modules such as intra/inter prediction, transform, quantization, in-loop filtering, and entropy coding.

In such advanced video coding standards, 16×16 macroblocks (in H.264) or up to 64×64 coding units (in HEVC) may be divided into smaller partition units and encoded. To support all possible partition sizes and to find the optimal combination, a video encoder may evaluate the encoding cost of all possible partitioning options, resulting in an extremely high computational complexity. Similarly for such advanced video coding standards, each macro block or coding unit may use a transform size that is N×N or smaller, where N is the coding unit size. So in addition to the complexity due to determining each partition size, the transform size determination may further increases the number of possible decisions and therefore computational complexity.

Such encoding techniques may provide efficiencies, but, as discussed, computational complexity remains high. As such, existing techniques do not provide reduced computational complexity while maintaining compression efficiency. Such problems may become critical as the desire to compress high quality video becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a flow diagram illustrating an example process for video encoding including an inter-prediction partition check bypass;

FIG. 2 is a flow diagram illustrating an example process for video encoding including an inter-prediction partition check bypass and modified transform size determination;

FIG. 3 illustrates an example macroblock and example macroblock partitions;

FIG. 4 illustrates an example coding tree unit and example coding units;

FIG. 5 illustrates an example quadtree partitioning of an example coding tree unit into example candidate coding units;

FIG. 6 illustrates a block diagram of an example encoder;

FIG. 7 illustrates a block diagram of an example flatness check module;

FIG. 8 illustrates a block diagram of an example inter-prediction module;

FIG. 9 illustrates an example encoded bitstream;

FIG. 10 is a flow diagram illustrating an example process for video coding;

FIG. 11 is an illustrative diagram of an example system for video encoding;

FIG. 12 is an illustrative diagram of an example system; and

FIG. 13 illustrates an example small form factor device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, apparatuses, computing platforms, and articles are described herein related to video coding and, in particular, to bypassing inter-prediction partition checks and/or transform size checks for portions of video frames.

As described above, in the implementation of advanced video coding standards, video encoders may evaluate encoding costs of all possible partition sizes and/or all possible transform sizes for portions (e.g., macroblocks or coding units or the like) of a video frame. Such techniques may provide coding efficiencies (e.g., greater compression) at the cost of high computational complexity. As discussed herein, inter-prediction partition checks and/or transform size checks may be bypassed for portions of a video frame based on a determination of whether the portion is flat or not flat. For example, if the portion is flat, inter-prediction partition checks and/or transform size checks may be bypassed saving computation complexity with minimal or no loss of coding efficiency and quality. Furthermore, if the portion is not flat, transform size checks may be bypassed in some examples.

For example, in some embodiments, a determination may be made as to whether a portion of a video frame is flat or not flat based on a flatness check of the portion of the video frame. For example, the flatness check may be based on a uniformity of the portion of the video frame as is discussed further herein. If the portion of the video frame is flat, an inter-prediction partition check for the portion of the video frame may be bypassed. In such examples, at a final mode decision may be performed using an inter-prediction coding cost based on an initial motion vector and initial inter-prediction partition choice based on integer motion estimation and fractional refinement (but without performing an inter-prediction partition check) as is discussed herein. For example, the final mode decision may be based on the inter-prediction coding cost, an intra-prediction coding cost, and a skip mode coding cost. Based on the final mode decision, the portion of the video frame may be encoded into a bitstream such as a standards compliant bitstream.

Furthermore, in some embodiments, based on the portion of the video frame being flat as determined via the flatness check, a transform size check may be bypassed and the transform size for the portion of the video frame may be set as a maximum transform size. The maximum transform size, for example, may be the same size as the portion of the video frame or a maximum available transform size based on the codec being implemented.

In examples where the portion of the video frame is determined to be not flat (or when another portion of the video frame is determined to be not flat), the inter-prediction partition check may be performed for the not flat portion to determine an inter-prediction coding cost based on a final motion vector and final inter-prediction partition choice determined via the inter-prediction partition check. Furthermore, a transform size check may be bypassed and the transform size for the portion of the video frame may be set to a minimum transform size. For example, the minimum transform size may be a minimum available transform size based on the codec being implemented.

Such partition mode, partition size, and transform size decision techniques may significantly reduce computational complexity at the encoder. For example, bypassing the inter-prediction partition check may avoid multiple hardware calls to evaluate encoding costs of different partition options or choices. Bypassing such evaluations may improve performance and reduce power consumption.

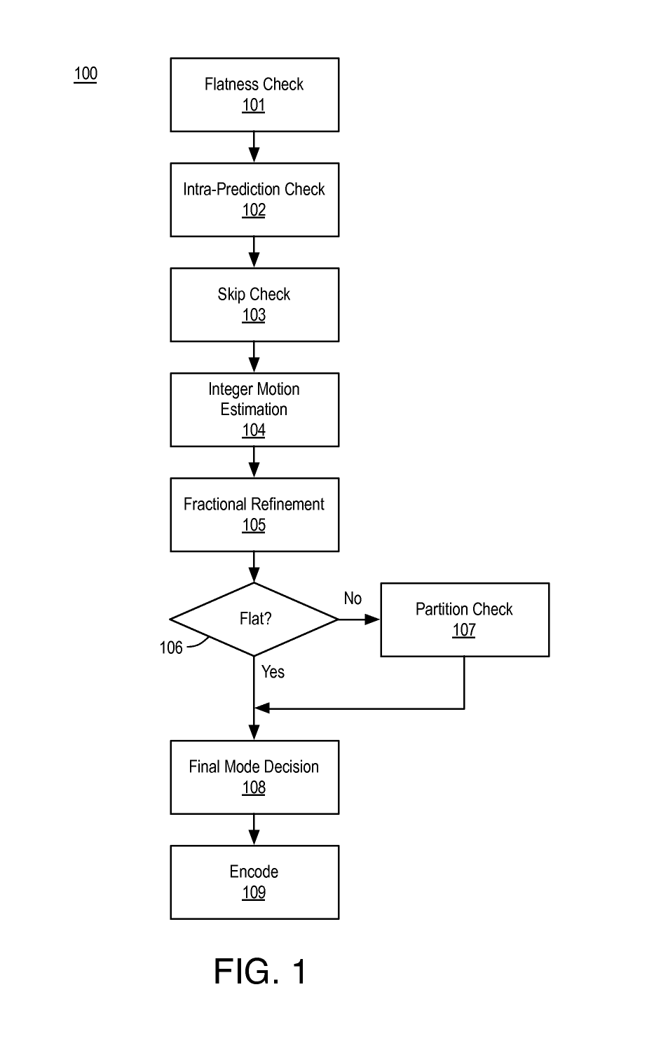

FIG. 1 is a flow diagram illustrating an example process 100 for video encoding including an inter-prediction partition check bypass, arranged in accordance with at least some implementations of the present disclosure. Process 100 may include one or more operations 101-109 as illustrated in FIG. 1. Process 100 may be performed by a device (e.g., encoder 600 as discussed herein) to determine a final mode for a portion of a video frame and to encode the portion based on the final mode decision. Process 100 may be performed at a coding block or unit level and process 100 may be repeated for any number of coding blocks or units.

For example, in the context of the H.264/MPEG-4 Advanced Video Coding (AVC) standard, the AVC standard defines a macroblock partition to refer to a block of pixels in a macroblock that share a common prediction mode such as motion vectors, reference frame index, reference prediction mode, or the like.

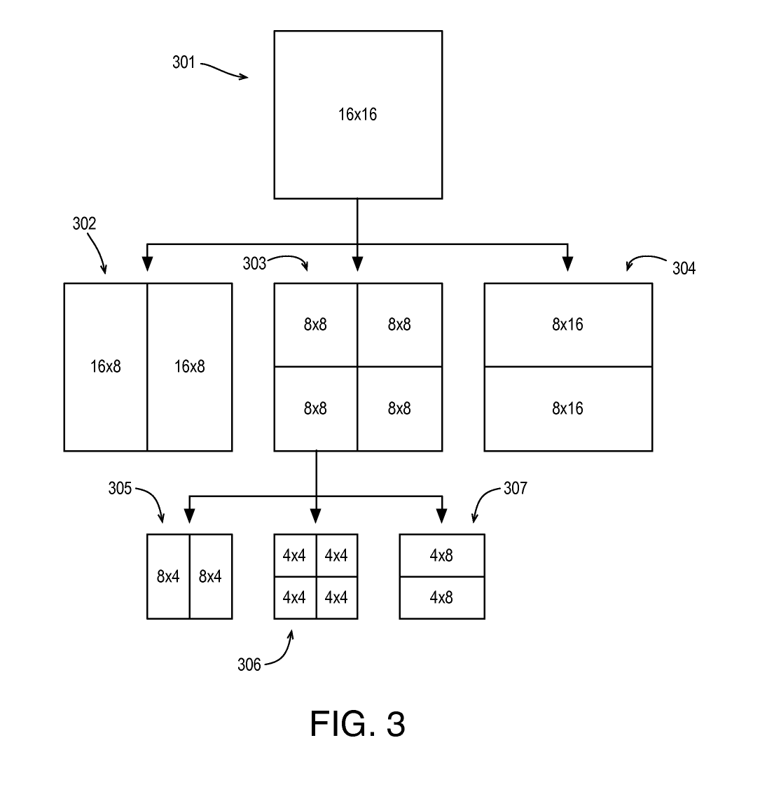

FIG. 3 illustrates an example macroblock and example macroblock partitions, arranged in accordance with at least some implementations of the present disclosure. As shown in FIG. 3, in the context of AVC, a macroblock 301 may be 16×16 pixels. Also as shown, macroblock 301 may be partitioned for coding into macroblock partitions 302, 303, 304. For example, macroblock partitions 302 may have two macroblock partitions each having a size of 16×8 pixels, macroblock partitions 303 may have four macroblock partitions each having a size of 8×8 pixels pixels, and macroblock partitions 304 may have two macroblock partitions each having a size of 8×16 pixels as shown.

Furthermore, each of the four partitions of macroblock partitions 303 may be further partitioned into macroblock partitions 305, 306, 307. In the example of FIG. 3, only one further partitioning is shown for the sake of clarity, however each of the four partitions of macroblock partitions 303 may be further partitions as illustrated with respect to macroblock partitions 305, 306, 307. As shown, macroblock partitions 305 may have two macroblock partitions each having a size of 8×4 pixels, macroblock partitions 306 may have four macroblock partitions each having a size of 4×4 pixels, and macroblock partitions 307 may have two macroblock partitions each having a size of 4×8 pixels.

In the context of AVC, macroblock partitions having a size larger than 8×8 pixels may be described as major shapes and macroblock partitions having a size smaller than 8×8 pixels may be described as minor shapes. As discussed, such macroblock partitions may be blocks of pixels that share a common prediction mode such as motion vectors, reference frame index, reference prediction mode, or the like for coding.

Furthermore, in the context of High Efficiency Video Coding (HEVC), the HEVC standard defines a coding tree unit (CTU) for a picture (e.g., a video frame of a video sequence) that may be partitioned into coding units (CUs) that take the form of rectangular blocks having variable sizes. The size of the coding tree unit may be selected by the encoder and may typically have a size of 64×64 pixels.

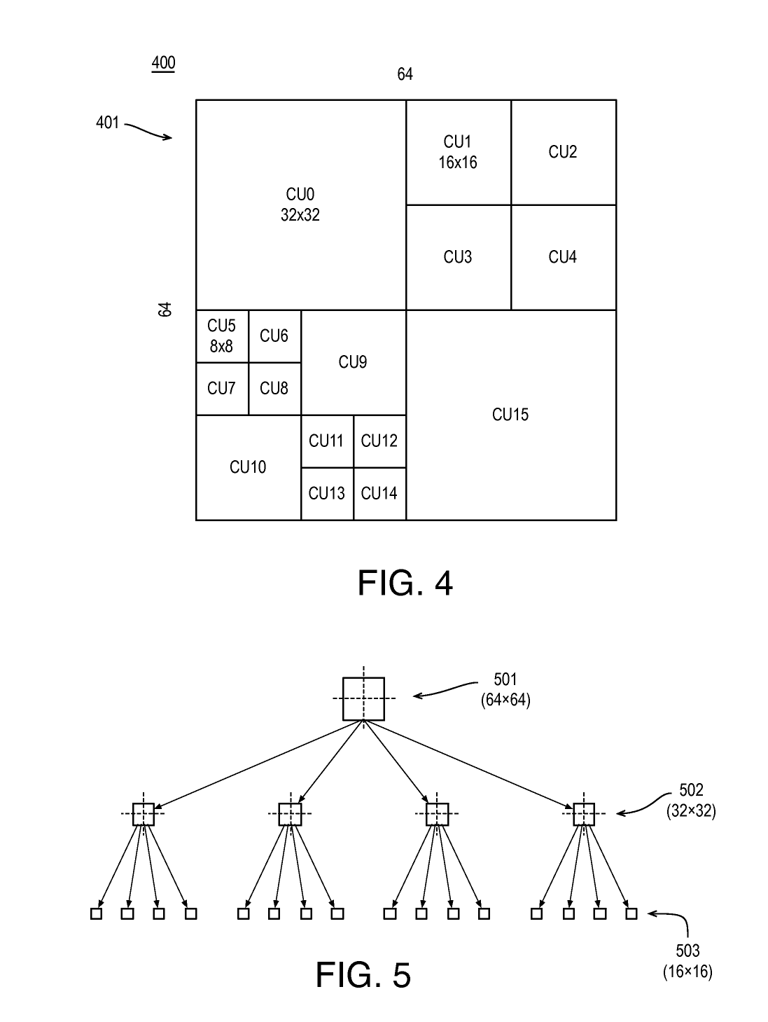

FIG. 4 illustrates an example coding tree unit and example coding units, arranged in accordance with at least some implementations of the present disclosure. As shown in FIG. 4, in the context of HEVC, a coding tree unit 400 may be 64×64 pixels, which may define a largest coding unit (LCU). Also as shown, coding tree unit 400 may be partitioned for coding into coding units 401, which are labeled as CU0-CU15 in FIG. 4. Furthermore, coding unit 0 (CU0) is labeled with its size, 32×32 pixels, coding unit 1 (CU1) is labeled with its size, 16×16 pixels, and coding unit 5 (CU5) is labeled with its size, 8×8 pixels. In the example of FIG. 4 coding units having the same size are shown with the same size of blocks such that CU15 is 32×32 pixels, CU2, CU3, CU4, CU9, and CU10 are 16×16 pixels, and CU6, CU7, CU8, CU11, CU12, CU13, and CU14 are 8×8 pixels.

FIG. 4 illustrates an example partitioning choice including coding units 401. However, coding tree unit 400 may be partitioned into any coding units 401. For example, coding tree unit 400 may be partitioned based on a quadtree syntax or similar data structure.

FIG. 5 illustrates an example quadtree partitioning of an example coding tree unit into example candidate coding units, arranged in accordance with at least some implementations of the present disclosure. As shown in FIG. 5 a syntax may be provided to partition a coding tree unit or largest coding unit into coding units for evaluation. For example, at a first or root level 501, a coding unit of size 64×64 may be provided for evaluation. The coding unit at the first level may be partitioned into four quadrants and each quadrant (e.g., of size 32×32) may be provided at a second level 502 as a coding unit (e.g., 4 coding units) for evaluation. Each of the coding units at second level 502 may be partitioned into four quadrants and each quadrant (e.g., of size 16×16) may be provided at a third level 503 as a coding unit (e.g., 16 coding units) for evaluation. Such a process may be repeated for a fourth level (having 64 coding units of size 8×8; not shown) and a fifth level (having 256 coding units of size 4×4; not shown), and so on unit a minimum allowable coding unit size is reached. Although discussed with respect to a quadtree syntax, any suitable syntax or partitioning technique may be used.

Returning to FIG. 1, process 100 may begin at operation 101, “Flatness Check”, where a flatness check may be performed for a portion of the video frame to determine whether the portion is flat or not flat. For example, operation 101 may be performed on or for a macroblock, a coding tree unit, or a largest coding unit as discussed herein. In other examples, operation 101 may be performed on or for any coding block of a video frame. In some examples, operation 101 may be performed on an entire video frame and the results may be stored in a data structure allowing for a determination whether a portion of a video frame is flat. For example, flat or not flat bits may be stored indicating whether portions are flat or not flat for a predefined segmentation of a video frame or the like. In other examples, regions of the video frame larger than the discussed portions may be defined as flat or not flat and a determination may be made as to whether a particular portion (e.g., macroblock or coding unit) is within a flat or not flat region of the video frame.

Operation 101 may be performed in hardware, software, or a combination thereof and operation 101 may use any suitable technique or techniques that may determine whether the portion of the video frame is flat or not flat. For example, a uniformity of the portion of the video frame may be evaluated to determine whether it is flat or not flat. In an example, a uniformity of the pixels or pixel values (e.g., luma and/or chroma values) of the portion of the video frame may be measured and compared to a threshold.

For example, a pixel variance of the portion of the video frame may be compared to a threshold to determine whether the portion of the video frame is flat or not flat. In an example, if a pixel variance of the portion of the video frame is less than a threshold, the portion of the video frame is flat and if the pixel variance is greater than the threshold, the portion of the video frame is not flat.

In another example, all or some of the pixel values of the portion of the video frame may be evaluated to determine whether they are within a threshold of an average or median of the pixel values of the portion of the video frame. For example, an average or median or the like of the pixel values may be determined for the portion of the video frame and, if each or a certain percentage or select pixels of the pixels are within a threshold of the average or median, the portion of the video frame is flat and, if not, the portion of the video frame is not flat.

In another example, a range of the pixel values of the portion of the video frame may be compared to a threshold to determine whether the portion of the video frame is flat. For example, a range of the pixel values may be determined (and, in some examples, outliers may be discarded) and the range may be compared to a threshold such that, if the range is less than the threshold, the portion of the video frame is flat and, if the range is greater than the threshold, the portion of the video frame is not flat.

In some examples, a single test or comparison may be used to determine whether the portion of the video frame is flat or not flat. In other examples, two or more comparison tests may be combined (e.g., via a weighted averaging or in a cascade of tests) to determine whether the portion of the video frame is flat or not flat. Furthermore, the discussed thresholds may be a predetermined threshold or a variable threshold based on the content of the video frame or video segment being evaluated, a power management setting of the device performing encoding, or the like.

As shown, process 100 may continue at operation 102, “Intra-Prediction Check”, where an intra-prediction check may be performed for the portion of the video frame. The intra-prediction check may be performed using any suitable technique or techniques. For example, the intra-prediction check may provide, for the portion of the video frame, a best intra-prediction mode and associated intra-prediction encoding cost. In some examples, the intra-prediction check may include an evaluation of all candidate intra-prediction modes available for the portion of the video frame to determine an intra-prediction mode having a minimum distortion for the portion of the video frame.

Process 100 may continue at operation 103, “Skip Check”, where a skip check may be performed for the portion of the video frame. The skip check may be performed using any suitable technique or techniques. For example, the skip check may provide, for the portion of the video frame, a skip check encoding cost associated with a skip mode for the portion of the video frame. In the skip mode, the decoder may determine the motion vector using a predetermined technique based on data available at the decoder such as a median value of three available motion vectors associated with (previously decoded) neighboring portions of the video frame. Furthermore, as discussed, a skip mode encoding cost for the portion of the video frame may be determined.

Process 100 may continue at operation 104, “Integer Motion Estimation”, where an integer motion estimation may be performed for the portion of the video frame. The integer motion estimation may be performed using any suitable technique or techniques and may provide an integer level estimate of a best motion vector and an inter-prediction partition choice for the portion of the video frame. For example, the integer motion estimation may search for a best integer level motion vector among candidate motion vectors within a reference frame for candidate partitions of the portion of the video frame. The integer motion estimation may check any number of candidate motion vectors. In some examples, in evaluating candidate partitions of the portion of the video frame, a tree pruning approach may be applied.

For example, with reference to FIG. 3, if a determination is made that the cost of encoding macroblock 301 as macroblock partitions 302 (e.g., as two 16×8 partitions) is less than the cost of encoding macroblock 301 as macroblock partitions 303 (e.g., as four 8×8 partitions), then macroblock 301 will not be partitioned into macroblock partitions 305-307 (e.g., those macroblock partitions will not be evaluated). Furthermore, with reference to FIG. 5, if the left-most path from first level 501 is determined to have the lowest cost at second level 502, only the four left-most paths from second level 502 to third level 503 may be evaluated and the twelve other paths from second level 502 to third level 503 may be skipped. Such techniques may provide a tree pruning approach since various branches of the tree structure may not be evaluated at operation 104.

Process 100 may continue at operation 105, “Fractional Refinement”, where a fractional refinement may be performed based on the best integer motion vector and inter-prediction partition choice. The fractional refinement may be performed using any suitable technique or techniques and may provide a fractional estimate of a best motion vector and an inter-prediction partition choice for the portion of the video frame. For example, the motion vector and the inter-prediction partition choice may be described as an initial motion vector and initial inter-prediction partition choice as described herein. In an example, the fractional refinement may include interpolated fractional (e.g., at half-pel or quarter-pel accuracy) evaluations of fractional candidate motion vectors based on the estimate motion vector and inter-prediction partition choice determined at operation 104.

For example, operations 104 and 105 may work together to determine an initial motion vector and initial inter-prediction partition choice for the portion of the video frame. The initial motion vector and initial inter-prediction partition choice may be associated with a cost for encoding based on the initial motion vector and initial inter-prediction partition choice, for example.

As shown, process 100 may continue at decision operation 106, “Flat?”, where a determination may be made as to whether the portion of the video frame is flat or not flat. Such a determination may be made based on the determination made at operation 101, using data determined at operation 101 and the discussed threshold comparisons, or the like.

As shown in FIG. 1, if the portion of the video frame is determined to be not flat, process 100 may continue at operation 107, “Partition Check”, where an inter-prediction partition check may be performed for the portion of the video frame. The partition check may be performed using any suitable technique or techniques and may generate a final motion vector and final inter-prediction partition choice for the portion of the video frame. For example, as discussed with respect to operation 104, a tree pruning approach may be implemented at the integer motion estimation and fractional refinement operations such that a portion of the tree structure (and the evaluations associated therewith) for the portion of the video frame may be skipped. At operation 107, such skipped portions of the tree structure and such skipped candidate partition options may be evaluated based on the initial motion vector (and, optionally, fractional repeats of the initial motion vector) generated at operation 105. For example, operation 107 may include a full partition options evaluation technique that evaluates all remaining partition options for the portion of the video frame.

For example, the inter-prediction partition check may determine the final motion vector and final inter-prediction partition choice for the portion of the video frame based on a minimum cost or distortion from the candidate partition options and optional fractional repeats. In some embodiments, such an inter-prediction partition check may include calls to a hardware video motion estimation engine to evaluate the many candidate partition options and optional fractional repeats.

Returning to decision operation 106, if the portion of the video frame is determined to be flat, process 100 may bypass operation 107 (e.g., an inter-prediction partition check may be bypassed based on the portion of the video frame being flat). Such bypass processing may advantageously reduce computational complexity as the described hardware calls or the like associated with an inter-prediction partition check may be eliminated.

As shown, processing may continue from operation 107 (if the portion of the video frame is not flat) or decision operation 106 (if the portion of the video frame is flat) at operation 108, “Final Mode Decision”, where a final mode decision may be made for the portion of the video frame. The final mode decision may be made using any suitable technique or techniques. For example, the final mode decision may be made based on a minimum cost of encoding of multiple candidate or available coding modes or types. In some examples, the final mode decision may include a rate distortion optimization.

For example, if the portion of the video frame is not flat, an intra-prediction mode coding cost (e.g. a minimum intra-prediction coding cost associated with a best intra-mode coding mode determined at operation 102), a skip mode coding cost (e.g., an encoding cost associated with coding via a skip mode as determined at operation 103), and an inter-prediction mode coding cost associated with the final motion vector and the final inter-prediction partition choice for the portion of the video frame (e.g., an encoding cost associated with the final motion vector and final inter-prediction partition choice as determined at operation 107) may be available. At operation 108, the coding costs may be compared and the coding candidate with the lowest cost may be selected for coding the portion of the video frame.

If the portion of the video frame is flat, an intra-prediction mode coding cost (e.g. a minimum intra-prediction coding cost associated with a best intra-mode coding mode determined at operation 102), a skip mode coding cost (e.g., an encoding cost associated with coding via a skip mode as determined at operation 103), and an inter-prediction mode coding cost associated with the initial motion vector and the initial inter-prediction partition choice for the portion of the video frame (e.g., an encoding cost associated with the initial motion vector and initial inter-prediction partition choice as determined at operation 105) may be available. At operation 108, the coding costs may be compared and the coding candidate with the lowest cost may be selected for coding the portion of the video frame.

As described, at operation 108, for flat portions, an initial motion vector and initial inter-prediction partition choice may be used for the final mode decision or selection and the determination of a final motion vector and final inter-prediction partition choice may be bypassed or skipped. Such processing may substantially reduce computational complexity as partition candidates associated with previously pruned portions of the tree structures discussed herein are not evaluated.

Process 100 may continue at operation 109, “Encode”, where the portion of the video frame may be encoded, based on the final mode decision determined at operation 108, into a bitstream. For example, the bitstream may be a standards (e.g., AVC, HEVC, V9, or the like) compliant bitstream. For example, residuals associated with the portion of the video frame may be quantized and transformed and other data (e.g., mode selection data, motion vector residuals, if applicable, or the like) may be entropy encoded into the bitstream.

As discussed, process 100 may provide reduced computational complexity based on a bypassing an inter-prediction partition check for portions of a video frame that are determined to be flat. In some embodiments, for flat portions of the video frame, a transform size check may also be skipped and the transform size for the portion may be set to a maximum transform size based on the portion of the video being flat. In other embodiments, for not flat portions of the vide frame, a transform size check may be implemented or the transform size for the portion may be set to a minimum transform size based on the portion of the video being not flat.

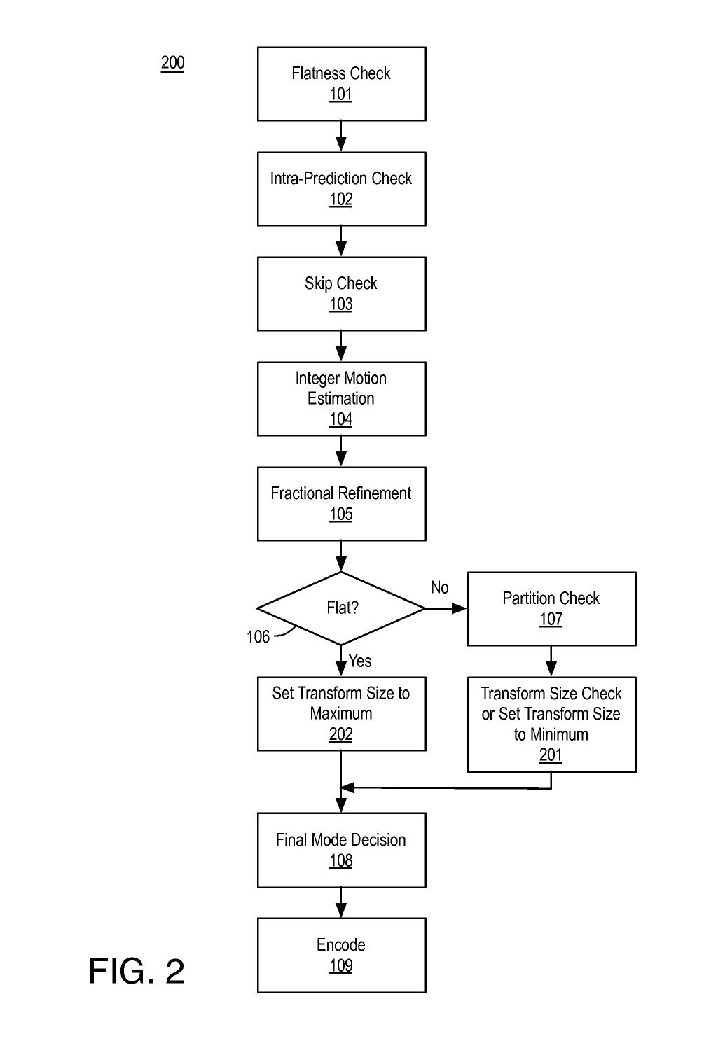

FIG. 2 is a flow diagram illustrating an example process 200 for video encoding including an inter-prediction partition check bypass and modified transform size determination, arranged in accordance with at least some implementations of the present disclosure. Process 200 may include one or more operations 101-109, 201, and 202 as illustrated in FIG. 2. Process 200 may be performed by a device (e.g., encoder 600 as discussed herein) to determine a final mode and transform size(s) for a portion of a video frame and to encode the portion based on the final mode decision and the transform size(s). Process 200 may be performed at a coding block or unit level and process 200 may be repeated for any number of coding blocks or units.

For example, process 100 may operate on macroblocks, coding tree units, largest coding units, coding units, coding blocks, or any other portion of a video frame as discussed herein. As shown, process 200 may begin at operation 101 and continue through operations 102, 103, 104, 105, and decision operation 106 as discussed herein with respect to FIG. 1. As discussed, operation 101 may provide a determination or data structure indicating whether the portion of the video frame is flat or not flat, operation 102 may provide a best intra-prediction mode and associated intra-prediction cost for the portion of the video frame, operation 103 may provide a skip check cost associated with a skip mode for the portion of the video frame, operation 104 may provide an integer level estimate of a best motion vector and an inter-prediction partition choice for the portion of the video frame, and operation 105 may provide an initial motion vector and initial inter-prediction partition choice for the portion of the video frame at a fractional precision.

As discussed with respect to FIG. 1, at decision operation 106, “Flat?”, a determination may be made as to whether the portion of the video frame is flat or not flat. Such a determination may be made based on a determination made at operation 101, using data determined at operation 101 and the discussed threshold comparisons, or the like.

As shown in FIG. 2, if the portion of the video frame is determined to be not flat, process 200 may continue at operation 107, “Partition Check”, where an inter-prediction partition check may be performed for the portion of the video frame. As discussed, the partition check may be performed using any suitable technique or techniques and may generate a final motion vector and final inter-prediction partition choice for the portion of the video frame. For example, at operation 107, candidate partition options associated with portions of a tree structure skipped at operation 104 may be evaluated based on the initial motion vector generated at operation 105. Furthermore, at operation 107, fractional repeats based on the initial motion vector may be evaluated. The candidate motion vector and candidate inter-prediction partition choice associated with a minimum encoding cost may be selected as the final motion vector and final inter-prediction partition choice for the portion of the video frame. For example, the final motion vector and final inter-prediction partition choice for the portion of the video frame may be a inter-prediction candidate for the final mode decision determined at operation 108.

Process 200 may continue from operation 107 at operation 201, “Transform Size Check or Set Transform Size to Minimum”, where a transform size check may be performed for the portion of the video frame or a transform size may be set to a minimum size for the portion of the video frame.

In some embodiments, a transform size check may be performed for the portion of the video frame. The transform size check may be performed using any suitable technique or techniques. For example, the transform size check may performed by evaluating all available transform sizes for the portion of the video frame. For example, if a given portion of the video frame is M×M pixels, transform sizes of M/2×M/2, M/4×M4, and so on may be evaluated for a lowest encoding cost. In some examples, the encoder may first select a coding partitioning of the portion of the video frame and then determine the transform size based on the coding partitioning.

In other embodiments, the full transform size check may be bypassed and the transform size may be set to a minimum transform size. For example, the minimum transform size may be based on a minimum transform size allowed by the codec being implemented. In some examples, the minimum transform size may be a 4×4 transform. Such bypass of the transform size check and setting the transform size to a minimum transform size may reduce computational complexity and save power as discussed herein.

Returning to decision operation 106, if the portion of the video frame is determined to be flat, process 100 may bypass operations 107 and 201 (e.g., an inter-prediction partition check may be bypassed based on the portion of the video frame being flat and a transform size check may be bypassed based on the portion of the video frame being flat) and continue at operation 202, “Set Transform Size to Maximum”, where the transform size for the portion of the video frame may be set to a maximum transform size. For example, the maximum transform size may be a size of the portion of the video frame, a maximum transform size allowed by the codec being implemented, or the like. In the context of AVC, the maximum transform size may be 8×8 and, in the context of HEVC, the maximum transform size may be 32×32, however any suitable maximum transform size may be used.

As discussed, process 200 may bypass operations 107 and 201 if the portion of the video frame is determined to be flat. Furthermore, if the portion of the video frame is determined to be flat, process 200 may automatically select a transform size for the portion of the video frame as a maximum transform size. Such bypass processing may advantageously reduce computational complexity as computationally intensive operations such as inter-prediction partition checks and/or transform size checks may be eliminated while only negligibly reducing coding quality.

As shown, processing may continue from operation 201 (if the portion of the video frame is not flat) or decision operation 202 (if the portion of the video frame is flat) at operation 108, “Final Mode Decision”, where a final mode decision may be made for the portion of the video frame. The final mode decision may be made using any suitable technique or techniques. For example, the final mode decision may be made based on a minimum cost of encoding of multiple candidate or available coding modes or types. In some examples, the final mode decision may include a rate distortion optimization.

As discussed with respect to FIG. 1, if the portion of the video frame is not flat, an intra-prediction mode coding cost, a skip mode coding cost, and an inter-prediction mode coding cost associated with the final motion vector and the final inter-prediction partition choice for the portion of the video frame (e.g., an encoding cost associated with the final motion vector and final inter-prediction partition choice as determined at operation 107) may be used for the final mode decision. If the portion of the video frame is not flat, an intra-prediction mode coding cost, a skip mode coding cost, and an inter-prediction mode coding cost associated with the initial motion vector and the initial inter-prediction partition choice for the portion of the video frame (e.g., an encoding cost associated with the initial motion vector and initial inter-prediction partition choice as determined at operation 105) used for the final mode decision. At operation 108, the coding costs may be compared and the coding candidate with the lowest cost may be selected for coding the portion of the video frame.

Process 100 may continue at operation 109, “Encode”, where the portion of the video frame may be encoded, based on the final mode decision determined at operation 108 and the transform size(s) selected at operation 202 or operation 201, into a bitstream. For example, the bitstream may be a standards (e.g., AVC, HEVC, V9, or the like) compliant bitstream. For example, residuals associated with the portion of the video frame may be quantized and transformed based on the transform size(s) selected at operation 202 or operation 201. The resultant transform coefficients and other data (e.g., mode selection data, motion vector residuals, if applicable, transform size indicators, or the like) may be entropy encoded into the bitstream.

The techniques discussed with respect to process 100 and process 200 may provide reduced computational complexity based on a bypassing an inter-prediction partition check and/or a transform size check for portions of a video frame that are determined to be flat. In some implementations, such techniques may save up to 40% of the workload on a video motion estimation engine or similar motion estimation circuitry with negligible quality impact. Furthermore, as high-definition, ultra-high definition, and 4K displays become more prevalent, the techniques discussed herein may provide higher performance savings as the video frames associated with such display technologies have more flat areas and therefore more flat portions, macroblocks, coding units, or the like.

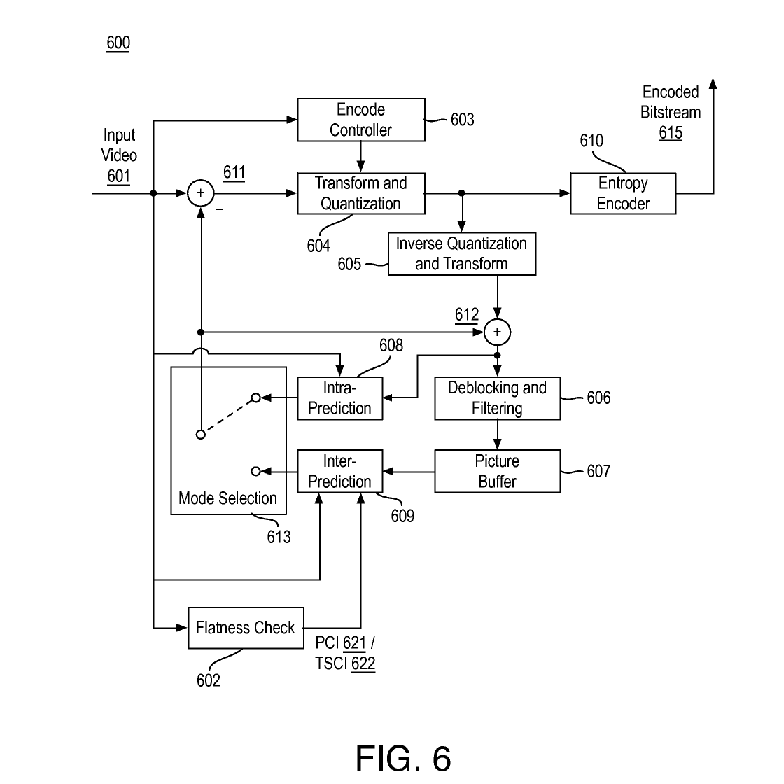

FIG. 6 illustrates a block diagram of an example encoder 600, arranged in accordance with at least some implementations of the present disclosure. As shown, encoder 600 may include a flatness check module 602, an encode controller 603, a transform and quantization module 604, an inverse quantization and transform module 605, a deblocking and filtering module 606, a picture buffer 607, an intra-prediction module 608, an inter-prediction module 609, a mode selection module 613, and an entropy encoder 610. Encoder 600 may include additional modules and/or interconnections that are not shown for the sake of clarity of presentation.

As discussed herein, a flatness check may be made for portions of a video frame. Such a flatness check may be used to bypass inter-prediction checks and/or transform size checks. As shown in FIG. 6, encoder 600 may receive input video 601. Input video 601 may be in any suitable format and may be received via any suitable technique such as video capture or via memory or the like. Furthermore, input video 601 may be processed (not shown) to determine portions of video frames (e.g., macroblocks, coding tree units, largest coding units, coding units, coding blocks, or any other portion of a video frame). As shown, input video 601 may be provided to flatness check module 602, encode controller 603, intra-prediction module 608, and inter-prediction module 609. The coupling to intra-prediction module 608 or inter-prediction module 609 may be made via mode selection module 613 as shown. For example, mode selection module 613 may make final mode decisions for portions of video frames of input video 601.

Flatness check module 602 may determine whether a portion of a video frame (e.g., a macroblock, a coding tree unit, a largest coding unit, a coding unit, a coding block, or the like, as discussed) is flat or not flat. Flatness check module 602 may implement any flatness check as discussed with respect to operation 101 and decision operation 106 to determine a portion of a video frame is flat or not flat. For example, flatness check module 602 may implement one or both of operation 101 and decision operation 106. As shown, flatness check module 602 may provide a partitions check indicator (PCI) 621 and/or a transform sizes check indicator (TSCI) 622 to inter-prediction module 609 based on the flatness determination.

For example, if the portion of the video frame is flat, flatness check module 602 may provide partitions check indicator 621 indicating no partitions check is to be performed (e.g., the partitions check is to be bypassed) for the portion of the video frame. If the portion of the video frame is not flat, flatness check module 602 may provide partitions check indicator 621 indicating a partitions check is to be performed for the portion of the video frame.

Furthermore, if the portion of the video frame is flat, flatness check module 602 may provide transform sizes check indicator 622 indicating no transform check is to be performed and the transform size is to be set to a maximum transform size. If the portion of the video frame is not flat, flatness check module 602 may provide transform sizes check indicator 622 indicating a transform size check is to be performed in some examples or indicating the transform size is to be set to a minimum transform size in other examples.

Inter-prediction module 609 may perform motion estimation and/or motion compensation for video frames of input video 601 at least partially based on partitions check indicator 621 and/or a transform sizes check indicator 622.

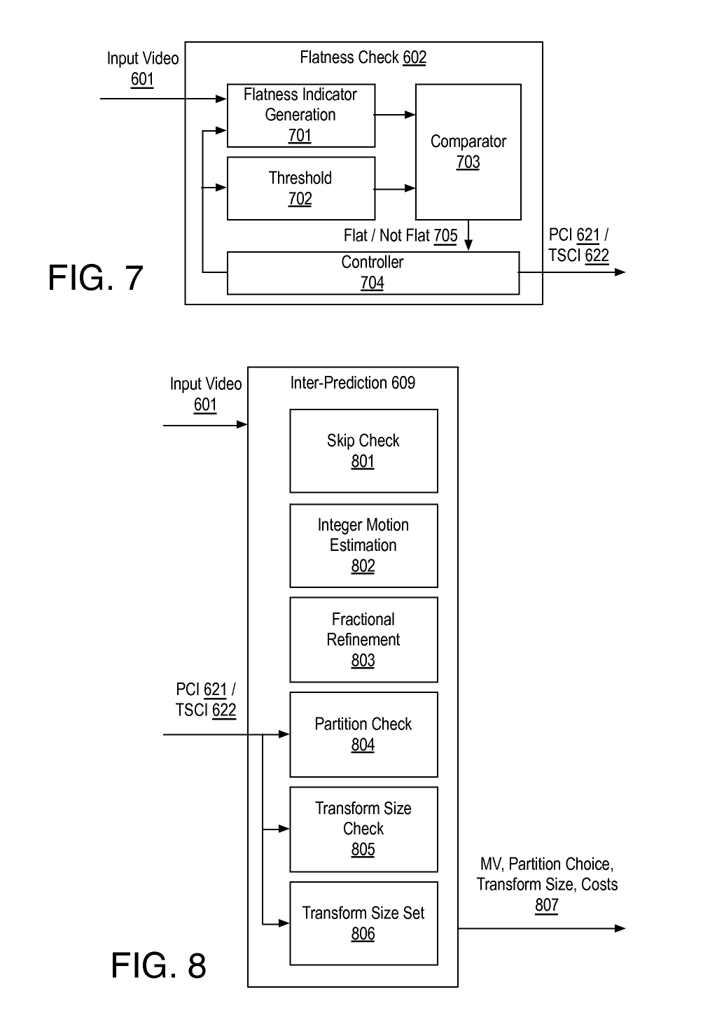

FIG. 7 illustrates a block diagram of an example flatness check module 602, arranged in accordance with at least some implementations of the present disclosure. As shown in FIG. 7, flatness check module 602 may include a flatness indicator generation module 701, a threshold module 702, a comparator 703, and a controller 704. As shown, flatness check module 602 may receive input video 601 via flatness indicator generation module 701. Based on input video 601, flatness indicator generation module 701 may generate one or more indicators for a portion of a video frame and flatness indicator generation module 701 may provide such indicator(s) to comparator 703. For example, the indicator(s) may include a pixel variance for the portion, a range of pixel values for the portion, a median of the pixel values, an average of the pixel values, or the like. In some examples, flatness indicator generation module 701 may generate the one or more indicators under the control of controller 704 such that particular indicator(s) may be used for the flatness determination based on system parameters, user settings, or the like.

Furthermore, threshold module 702 may provide one or more thresholds to comparator 703. For example, threshold module 702 may be implemented via memory (e.g., a cache memory) and may store one or more thresholds. In some examples, threshold module 702 may provide the one or more indicators under the control of controller 704 as discussed with respect to flatness indicator generation module 701. Also as shown, comparator 703 may receive the indicator(s) and the threshold(s) and comparator 703 may provide a flat/not flat indicator 705 to controller 704 for the portion of the video frame. For example, comparator 703 may generate flat/not flat indicator 705 based on comparing one or more of the indicators to one or more of the thresholds. In an example, the flatness of the portion of the video frame may be based on comparator 703 comparing a pixel variance to a threshold, determining whether all pixel vales are within a second threshold of an average of the pixel values, determining whether all pixel vales are within a third threshold of a median of the pixel values, a comparison of a range of the pixel values to a fourth threshold, or a combination thereof.

As shown, controller 704 may receive flat/not flat indicator 705 and controller 704 may provide partitions check indicator 621 and/or a transform sizes check indicator 622. For example, based on flat/not flat indicator 705 and/or other control parameters or settings or the like, controller may provide partitions check indicator 621 and/or transform sizes check indicator 622. In examples where flat/not flat indicator 705 indicates the portion of the video frame is flat, controller 704 may provide partitions check indicator 621 indicating a partitions check is to be bypassed and transform sizes check indicator 622 indicating a transform size check is to be skipped and the transform size is to be set to a maximum transform size. In examples where flat/not flat indicator 705 indicates the portion of the video frame is not flat, controller 704 may provide partitions check indicator 621 indicating a partitions check is to be implemented and transform sizes check indicator 622 indicating either a transform size check is to be implemented or the transform size is to be set to a minimum transform size. The decision between implementing the transform size check or setting the transform size to a minimum transform size may be preset, based on user settings, or determined based on characteristics of encoder 600 such as processing capacity, battery life, power management settings or the like.

As discussed, partitions check indicator 621 and/or transform sizes check indicator 622 may be provided to inter-prediction module 609 to control, at least partially, the inter-prediction of the portion of the video frame.

FIG. 8 illustrates a block diagram of an example inter-prediction module 609, arranged in accordance with at least some implementations of the present disclosure. As shown in FIG. 8, inter-prediction module 609 may include a skip check module 801, an integer motion estimation module 802, a fractional refinement module 803, a partition check module 804, a transform size check module 805, and a transform size set module 806. As shown, inter-prediction module 609 may receive input video 601, partitions check indicator 621, and/or transform sizes check indicator 622.

Inter-prediction module 609 may perform motion estimation and/or motion compensation for video frames of input video 601 coded via inter-prediction techniques. For example, inter-prediction module 609 may perform skip check operations (e.g., as discussed with respect to operation 103) via skip check module 801, integer motion estimations (e.g., as discussed with respect to operation 104) via integer motion estimation module 802, and fractional refinements (e.g., as discussed with respect to operation 105) via fractional refinement module 803.

Furthermore, partition checks (e.g., as discussed with respect to operation 107) may be performed by partition check module 804 partially under control of partitions check indicator 621. For example, partition check module 804 may perform partition checks when partitions check indicator 621 indicates partition checks are to be performed (e.g., the current portion of the video frame is not flat) and partition check module 804 may not perform partition checks (e.g., partition checks may be bypassed) when partitions check indicator 621 indicates partition checks are to be bypassed (e.g., the current portion of the video frame is flat).

Also, transform size checks (e.g., as discussed with respect to operation 201 if transform size checks are enabled) may be performed via transform size check module 805 partially under control of transform sizes check indicator 622. For example, in some embodiments, transform size check module 805 may perform transform size checks when transform sizes check indicator 622 indicates transform size checks are to be performed (e.g., the current portion of the video frame is not flat) and partition check module 804 may not perform transform size checks (e.g., transform size checks may be bypassed) when transform sizes check indicator 622 indicates transform size checks are to be bypassed (e.g., the current portion of the video frame is flat). In other embodiments, transform size checks may not be performed for flat or not flat portions of a video frame. In such embodiments, transform size check module 805 may not be implemented.

As also shown via FIG. 8, transform size set module 806 may set a transform size for the portion of the video frame based on transform sizes check indicator 622. For example, if transform sizes check indicator 622 indicates a transform size is to be set to a maximum value (e.g., the current portion of the video frame is flat) or a minimum value (e.g., the current portion of the video frame is not flat and transform size check bypass is set), transform size set module 806 may set the transform size to the maximum transform size or the minimum transform size, respectively.

Furthermore, inter-prediction module 609 may provide motion vector, partition choice, transform size, and costs data 807, which may include a motion vector (initial or final) a partition choice (initial or final), a transform size, and a cost of encoding for the current portion of the video frame. For example, an initial motion vector and an initial partition choice (if applicable) may be provided via fractional refinement module 803, a final motion vector and a final partition choice (if applicable) may be provided via partition check module 804, and a transform size may be provided via transform size check module 805 or transform size set module 806. The costs may optionally be provided via a controller or distortion optimization module (not shown) of inter-prediction module 609. The costs may include a cost associated with the motion vector (initial or final) a partition choice (initial or final) and a cost associated with a skip mode. In other examples, the costs may be determined by mode selection module 613.

Returning to FIG. 6, the motion vector, partition choice, transform size, and/or costs data may be provide from inter-prediction module 609 to mode selection module 613. In some examples, the costs data may be provided form inter-prediction module 609 and, in other examples, the costs data may be determined by mode selection module 613. Furthermore, intra-prediction module 608 may perform intra-prediction for video frames of input video 601. For example, intra-prediction module 608 may perform intra-prediction check operations (e.g., as discussed with respect to operation 102) to determine a best intra-prediction mode for the portion of the video frame. The best intra-prediction mode and, optionally, an associated cost may be provide to mode selection module 613. In other examples, the intra-prediction cost may be determined by mode selection module 613.

As shown, mode selection module 613 (e.g., via a switch), may select between the best intra-prediction mode, the inter-prediction mode based on the inter-prediction motion vector and partition choice, and the skip mode. For example, mode selection module 613 may perform the final mode decision based on a minimum cost among an inter-prediction mode coding cost, an intra-prediction mode coding cost, and a skip mode coding cost for the portion of the video frame (e.g., as discussed with respect to operation 108).

Based on the mode selection, a predicted portion of the video frame may be differenced via differencer 611 with the original portion of the video frame (e.g., of input video 601) to generate a residual. The residual may be transferred to transform and quantization module 604, which may transform (e.g., via a discrete cosine transform or the like) the residual to determine transform coefficients and quantize the transform coefficients. The quantized transform coefficients may be encoded via entropy encoder 610 into encoded bitstream 615. Other data, such as motion vector residuals, modes data, transform size data, or the like may also be encoded and inserted into encoded bitstream 615 for the portion of the video frame.

Furthermore, the quantized transform coefficients may be inverse quantized and inverse transformed via inverse quantization and transform module 605 to generate a reconstructed residual. The reconstructed residual may be combined with the aforementioned predicted portion at adder 612 to form a reconstructed portion, which may be optionally deblocked and filtered via deblocking and filtering module 606 and/or optionally saved (along with other reconstructed portions of the current frame or picture) via picture buffer 607 and used for encoding other portions of the current or other video frames.

Such processing may be repeated for each portion of a video frame and for multiple video frames. The portion of the video frame may be encoded based on the mode selection and/or transform size selection discussed herein. The selected mode and/or transform size and the resultant bits may be included in encoded bitstream 615.

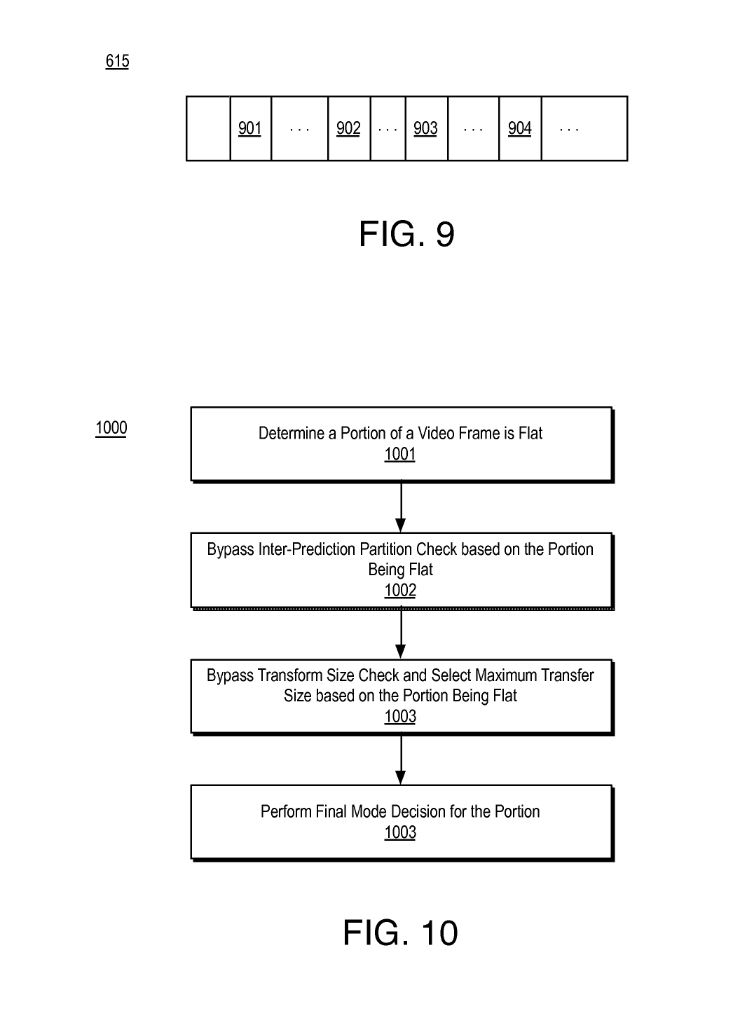

FIG. 9 illustrates an example encoded bitstream 615, arranged in accordance with at least some implementations of the present disclosure. In some examples, encoded bitstream 615 may be a High Efficiency Video Coding (HEVC) compliant bitstream, an H.264/MPEG-4 Advanced Video Coding (AVC) compliant bitstream, or a V9 compliant bitstream. Although not shown in FIG. 9, in some examples, encoded bitstream 615 may include a header portion or portions and a data portion or portions. Encoded bitstream 615 may include any suitable data associated with encoded video data. As shown in FIG. 9, encoded bitstream 615 may include encoded quantized transform coefficients 901, encoded modes data 902, encoded splits data 903, and encoded transform size data 904. As discussed, encoded bitstream 615 may be generated via entropy encoder 610 of encoder 600.

For example, encoded bitstream 615 may include encoded quantized transform coefficients 901 that include transform coefficients for a residual of a portion of a video frame as discussed herein. For example, a portion of a video frame may be encoded based on an encoding mode (e.g., intra, inter, or skip) selected as discussed herein. The residual between the predicted portion of a video frame and the original portion of a video frame may be transformed, quantized, encoded, and inserted into encoded bitstream as encoded quantized transform coefficients 901. Encoded bitstream 615 may also include encoded modes data 902. For example, encoded modes data 902 may include a mode or modes for the portion of a video frame selected as discussed herein. The selected mode or modes for the portion of a video frame (along with mode information for other portions of the video frame, for example) may be entropy encoded and inserted into encoded bitstream 615 as encoded modes data 902. Furthermore, encoded bitstream 615 may include encoded splits data 903. As discussed herein, for a portion of a video frame, a mode or modes and/or motion vectors or the like may be associated with partitions of a portion of a video frame (e.g., partitions of a macroblock or a tree coding unit or the like). Such partitioning information may be provided as splits data, which may be entropy encoded and inserted into encoded bitstream 615 as encoded splits data 903. Also as shown, transform size data as determined herein may be generated, entropy encoded and inserted into bitstream 615 as encoded transform size data 904. As discussed, encoded bitstream 715 may be generated via an encoder or encoder system such as, for example, encoder 600. Encoded bitstream 615 may be stored (e.g., as a file or container) to a memory (e.g., of system a system implementing encoder 600), stored (e.g., as a file or container) to a memory storage device (e.g., a disc, a server for download, or the like), or transmitted to a remote device. Furthermore, encoded bitstream 615 may be accessed (e.g., via reading a disc, streaming, downloading, or the like) by a decoder that may decode the bitstream and generate video frames or sequences of video frames for presentment to a user.

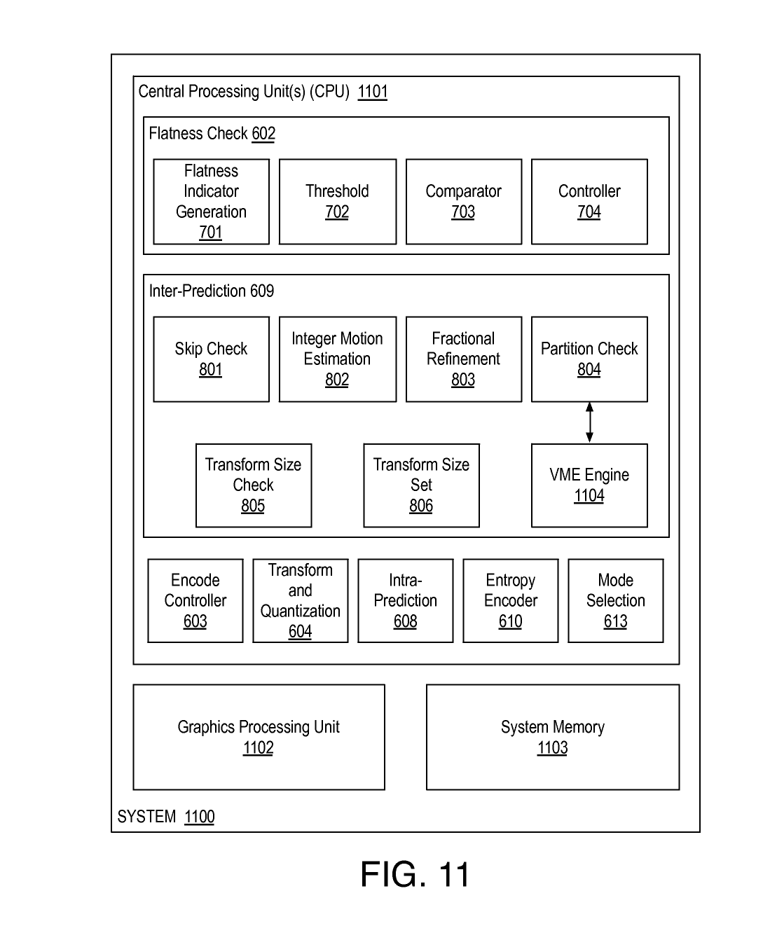

FIG. 10 is a flow diagram illustrating an example process 1000 for video coding, arranged in accordance with at least some implementations of the present disclosure. Process 1000 may include one or more operations 1001-1004 as illustrated in FIG. 10. Process 1000 may form at least part of a video coding process. By way of non-limiting example, process 1000 may form at least part of a video coding process performed by encoder 600 as discussed herein. Furthermore, process 1000 will be described herein with reference to system 1100 of FIG. 11.

FIG. 11 is an illustrative diagram of an example system 1100 for video encoding, arranged in accordance with at least some implementations of the present disclosure. As shown in FIG. 11, system 1100 may include one or more central processing units (CPU) 1101, a graphics processing unit (GPU) 1102, memory stores 1103, and a video motion estimation (VME) engine 1104. Also as shown, CPU 1701 may include flatness check module 602, inter-prediction module 609, encode controller 603, transform and quantization module 604, intra-prediction module 608, entropy encoder 610, and mode selection module 613. Furthermore, flatness check module 602 may include flatness indicator generation module 701, threshold module 702, comparator 703, and controller 704 and inter-prediction module 609 may include skip check module 801, integer motion estimation module 802, fractional refinement module 803, partition check module 804, transform size check module 805, transform size set module 806, and video motion estimation engine 1104. Such modules may be implemented to perform operations as discussed herein. In the example of system 1100, memory stores 1103 may store video data such as input video, video frames, pixel data for portions of video frames, partition data, splits data, modes data, encoding costs, motion vectors, flatness data, flatness thresholds, residual data, transform coefficients, bitstream data, or any other data as discussed herein.

As shown, in some examples, flatness check module 602, inter-prediction module 609, encode controller 603, transform and quantization module 604, intra-prediction module 608, entropy encoder 610, and mode selection module 613 may be implemented via central processing units 1101. In other examples, one or more or portions of flatness check module 602, inter-prediction module 609, encode controller 603, transform and quantization module 604, intra-prediction module 608, entropy encoder 610, and mode selection module 613 may be implemented via graphics processing unit 1102. In yet other examples, one or more or portions of flatness check module 602, inter-prediction module 609, encode controller 603, transform and quantization module 604, intra-prediction module 608, entropy encoder 610, and mode selection module 613 may be implemented via an encode pipeline and/or an imaging processing unit. Furthermore, one or more of integer motion estimation module 802, fractional refinement module 803, and partition check module 804 may access video motion estimation engine 1104. In particular, partition check module 804 may access video motion estimation engine 1104 via one or more calls to perform at least a portion of the partition check. In some examples, video motion estimation engine 1104 may be implemented via hardware of graphics processing unit 1102.

Graphics processing unit 1102 may include any number and type of graphics processing units that may provide the operations as discussed herein. Such operations may be implemented via software or hardware or a combination thereof. For example, graphics processing unit 1102 may include circuitry dedicated to manipulate frame or video data obtained from memory stores 1103. Central processing units 1101 may include any number and type of processing units or modules that may provide control and other high level functions for system 1100 and/or provide any operations as discussed herein. Memory stores 1103 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 1103 may be implemented by cache memory. In an embodiment, one or more or portions of flatness check module 602, inter-prediction module 609, encode controller 603, intra-prediction module 608, transform and quantization module 604, and entropy encoder 610 may be implemented via an execution unit (EU) of graphics processing unit 1102. The EU may include, for example, programmable logic or circuitry such as a logic core or cores that may provide a wide array of programmable logic functions. In an embodiment, one or more or portions of flatness check module 602, inter-prediction module 609, encode controller 603, intra-prediction module 608, transform and quantization module 604, and entropy encoder 610 may be implemented via dedicated hardware such as fixed function circuitry or the like. Fixed function circuitry may include dedicated logic or circuitry and may provide a set of fixed function entry points that may map to the dedicated logic for a fixed purpose or function.

Returning to discussion of FIG. 10, process 1000 may begin at operation 1001, “Determine a Portion of a Video Frame is Flat”, where a portion of a video frame may be determined to be flat based on a flatness check of the portion of the video frame. For example, flatness check module 602 as implemented via central processing unit 1101 may determine a portion of a video frame is flat using techniques discussed herein. The flatness check may include any suitable flatness check such as one or more of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold. The portion of the video frame may include any suitable portion of a video frame such as a macroblock, a coding unit, or the like.

As discussed, operation 1001 may determine a portion of a video frame is flat. In other examples, operation 1001 may determine a second portion of the video frame is not flat based on a second flatness check of the second portion of the video frame. For example, operation 1001 may, flatness check module 602 as implemented via central processing unit 1101, evaluate portions of video frames to determine whether they are flat or not flat.

Processing may continue at operation 1002, “Bypass Inter-Prediction Partition Check based on the Portion Being Flat”, where an inter-prediction partition check for the portion of the video frame may be bypassed based on the portion of the video frame being flat. For example, partition check module 804 (and associated calls to video motion estimation engine 1104) may not be implemented for the portion of the video frame.

For portions of the video frame that are determined to be not flat at operation 1001, such as the second portion of the video frame, an inter-prediction partition check may be performed based on the second portion of the video frame being not flat. Such a partition check may be performed by partition check module 804 and/or video motion estimation motion engine 1104 based on an initial motion vector and an initial inter-prediction partition choice for the second portion of the video frame generated via fractional refinement module 803 to determine a final motion vector and a final inter-prediction partition choice for the second portion of the video frame. For example, the initial motion vector and initial inter-prediction partition choice may be generated based on a tree pruning technique and the final motion vector and final inter-prediction partition choice may include a full partition options evaluation for the second portion of the video frame.

Processing may continue at operation 1003, “Bypass Transform Size Check and Select Maximum Transfer Size based on the Portion Being Flat”, where a transform size check for the portion of the video frame may be bypassed based on the portion of the video frame being flat and a maximum transform size for the portion of the video frame may be selected based on the portion of the video frame being flat. For example, transform size check 805 may be bypassed and transform size set 806 may be implemented to a set a maximum transform size for the portion of the video frame. In some examples, the maximum transform size may be a size of the portion of the video frame.

For portions of the video frame that are determined to be not flat at operation 1001, such as the second portion of the video frame, a transform size check may be performed, in some examples, based on the second portion of the video frame being not flat. For example, the transform size check may be performed by transform size check module 805 to determine a transform size for the second portion of the video frame. In other examples, the transform size check may be bypassed based on the second portion of the video frame being not flat. In such examples, a minimum transform size for the second portion of the video frame may be selected based on the portion of the video frame being not flat.

Processing may continue at operation 1004, “Perform Final Mode Decision for the Portion”, where a final mode decision for the portion of the video frame may be performed based at least in part on an inter-prediction mode coding cost for the portion of the video frame associated with an initial motion vector and an initial inter-prediction partition choice for the portion of the video frame. For example, the initial motion vector and the initial inter-prediction partition choice for the portion of the video frame may be determined via integer motion estimation module 802 and fractional refinement module 803 of inter-prediction module 609 as implemented via central processing unit 1101. The inter-prediction mode coding cost for the portion of the video frame associated with the initial motion vector and the initial inter-prediction partition choice may be determined via inter-prediction module 609 or other control circuitry and mode selection module 613 as implemented via central processing unit 1101 may perform the final mode decision. Furthermore, mode selection module 613 may perform the mode selection further based on an intra-prediction mode coding cost (e.g., as determined via intra-prediction module 608) for the portion of the video frame and a skip mode coding cost (e.g., as determined via skip check module 801) for the portion of the video frame.

For portions of the video frame that are determined to be not flat at operation 1001, such as the second portion of the video frame, a final mode decision may be performed based on an inter-prediction mode coding cost for the portion of the video frame associated with a final motion vector and a final inter-prediction partition choice for the portion of the video frame. Such a final mode decision may be performed further based on an intra-prediction mode coding cost for the second portion of the video frame and a skip mode coding cost for the second portion of the video frame. For example, the final motion vector and the final inter-prediction partition choice for the portion of the video frame may be determined via partition check module 804 and/or video motion estimation engine 1104.

Process 1000 may be repeated any number of times either in series or in parallel for any number of portions of a video and/or video frames. Process 1000 may provide for bypassing inter-prediction checks and/or transform size checks as discussed herein to save power, computational complexity, and processing time. Based on the mode decision, initial or final motion vector, initial or final inter-prediction partition choice, and/or transform size, the portion of the video frame may be encoded into a bitstream such as a standards compliant bitstream.

Various components of the systems described herein may be implemented in software, firmware, and/or hardware and/or any combination thereof. For example, various components of encoder 600 or system 1100 may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of systems 100 or 1700, or any other module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

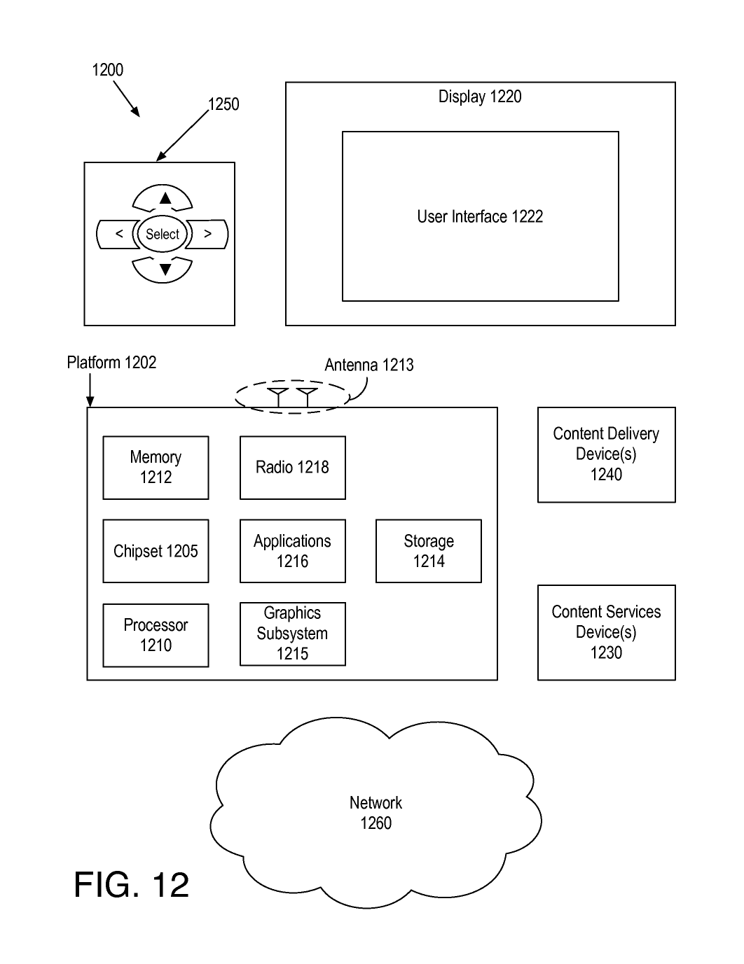

FIG. 12 is an illustrative diagram of an example system 1200, arranged in accordance with at least some implementations of the present disclosure. In various implementations, system 1200 may be a computing system although system 1200 is not limited to this context. For example, system 1200 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1200 includes a platform 1202 coupled to a display 1220. Platform 1202 may receive content from a content device such as content services device(s) 1230 or content delivery device(s) 1240 or other similar content sources. A navigation controller 1250 including one or more navigation features may be used to interact with, for example, platform 1202 and/or display 1220. Each of these components is described in greater detail below.

In various implementations, platform 1202 may include any combination of a chipset 1205, processor 1210, memory 1212, antenna 1213, storage 1214, graphics subsystem 1215, applications 1216 and/or radio 1218. Chipset 1205 may provide intercommunication among processor 1210, memory 1212, storage 1214, graphics subsystem 1215, applications 1216 and/or radio 1218. For example, chipset 1205 may include a storage adapter (not depicted) capable of providing intercommunication with storage 1214.

Processor 1210 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1210 may be dual-core processor(s), dual-core mobile processor(s), and so forth.

Memory 1212 may be implemented as a volatile memory device such as, but not limited to, a Random Access Memory (RAM), Dynamic Random Access Memory (DRAM), or Static RAM (SRAM).

Storage 1214 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1214 may include technology to increase the storage performance enhanced protection for valuable digital media when multiple hard drives are included, for example.

Graphics subsystem 1215 may perform processing of images such as still or video for display. Graphics subsystem 1215 may be a graphics processing unit (GPU) or a visual processing unit (VPU), for example. An analog or digital interface may be used to communicatively couple graphics subsystem 1215 and display 1220. For example, the interface may be any of a High-Definition Multimedia Interface, DisplayPort, wireless HDMI, and/or wireless HD compliant techniques. Graphics subsystem 1215 may be integrated into processor 1210 or chipset 1205. In some implementations, graphics subsystem 1215 may be a stand-alone device communicatively coupled to chipset 1205.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1218 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1218 may operate in accordance with one or more applicable standards in any version.

In various implementations, display 1220 may include any television type monitor or display. Display 1220 may include, for example, a computer display screen, touch screen display, video monitor, television-like device, and/or a television. Display 1220 may be digital and/or analog. In various implementations, display 1220 may be a holographic display. Also, display 1220 may be a transparent surface that may receive a visual projection. Such projections may convey various forms of information, images, and/or objects. For example, such projections may be a visual overlay for a mobile augmented reality (MAR) application. Under the control of one or more software applications 1216, platform 1202 may display user interface 1222 on display 1220.

In various implementations, content services device(s) 1230 may be hosted by any national, international and/or independent service and thus accessible to platform 1202 via the Internet, for example. Content services device(s) 1230 may be coupled to platform 1202 and/or to display 1220. Platform 1202 and/or content services device(s) 1230 may be coupled to a network 1260 to communicate (e.g., send and/or receive) media information to and from network 1260. Content delivery device(s) 1240 also may be coupled to platform 1202 and/or to display 1220.

In various implementations, content services device(s) 1230 may include a cable television box, personal computer, network, telephone, Internet enabled devices or appliance capable of delivering digital information and/or content, and any other similar device capable of uni-directionally or bi-directionally communicating content between content providers and platform 1202 and/display 1220, via network 1260 or directly. It will be appreciated that the content may be communicated uni-directionally and/or bi-directionally to and from any one of the components in system 1200 and a content provider via network 1260. Examples of content may include any media information including, for example, video, music, medical and gaming information, and so forth.

Content services device(s) 1230 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1202 may receive control signals from navigation controller 1250 having one or more navigation features. The navigation features of navigation controller 1250 may be used to interact with user interface 1222, for example. In various embodiments, navigation controller 1250 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 1250 may be replicated on a display (e.g., display 1220) by movements of a pointer, cursor, focus ring, or other visual indicators displayed on the display. For example, under the control of software applications 1216, the navigation features located on navigation controller 1250 may be mapped to virtual navigation features displayed on user interface 1222, for example. In various embodiments, navigation controller 1250 may not be a separate component but may be integrated into platform 1202 and/or display 1220. The present disclosure, however, is not limited to the elements or in the context shown or described herein.

In various implementations, drivers (not shown) may include technology to enable users to instantly turn on and off platform 1202 like a television with the touch of a button after initial boot-up, when enabled, for example. Program logic may allow platform 1202 to stream content to media adaptors or other content services device(s) 1230 or content delivery device(s) 1240 even when the platform is turned “off” In addition, chipset 1205 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1200 may be integrated. For example, platform 1202 and content services device(s) 1230 may be integrated, or platform 1202 and content delivery device(s) 1240 may be integrated, or platform 1202, content services device(s) 1230, and content delivery device(s) 1240 may be integrated, for example. In various embodiments, platform 1202 and display 1220 may be an integrated unit. Display 1220 and content service device(s) 1230 may be integrated, or display 1220 and content delivery device(s) 1240 may be integrated, for example. These examples are not meant to limit the present disclosure.

In various embodiments, system 1200 may be implemented as a wireless system, a wired system, or a combination of both. When implemented as a wireless system, system 1200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1202 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 12.

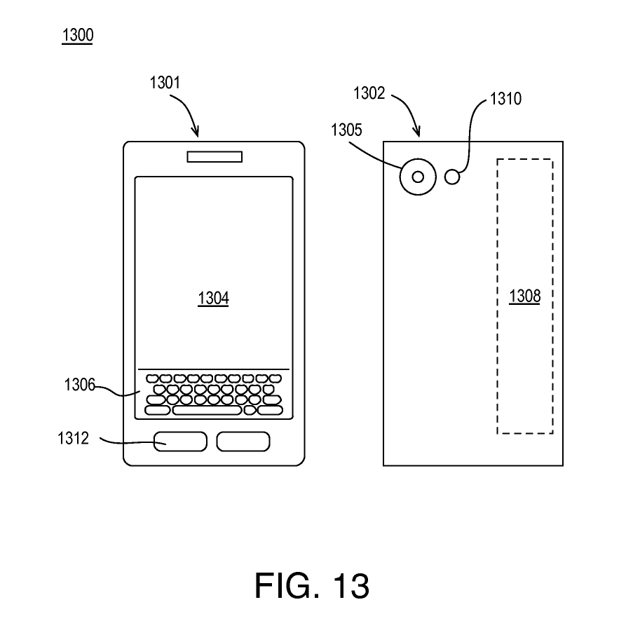

As described above, system 1200 may be embodied in varying physical styles or form factors. FIG. 13 illustrates an example small form factor device 1300, arranged in accordance with at least some implementations of the present disclosure. In some examples, system 1800 may be implemented via device 1300. In other examples, imaging device 101, system 900, or portions thereof may be implemented via device 1300. In various embodiments, for example, device 1300 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 13, device 1300 may include a housing with a front 1301 and a back 1302. Device 1300 includes a display 1304, an input/output (I/O) device 1306, and an integrated antenna 1308. Device 1300 also may include navigation features 1312. I/O device 1306 may include any suitable I/O device for entering information into a mobile computing device. Examples for I/O device 1306 may include an alphanumeric keyboard, a numeric keypad, a touch pad, input keys, buttons, switches, microphones, speakers, voice recognition device and software, and so forth. Information also may be entered into device 1300 by way of microphone (not shown), or may be digitized by a voice recognition device. As shown, device 1300 may include a camera 1305 (e.g., including a lens, an aperture, and an imaging sensor) and a flash 1310 integrated into back 1302 (or elsewhere) of device 1300. In other examples, camera 1305 and flash 1310 may be integrated into front 1301 of device 1300 or both front and back cameras may be provided. Camera 1305 and flash 1310 may be components of a camera module to originate image data processed into streaming video that is output to display 1304 and/or communicated remotely from device 1300 via antenna 1308 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one or more first embodiments, a computer-implemented method for video coding comprises determining a portion of a video frame is flat based on a flatness check of the portion of the video frame, bypassing an inter-prediction partition check for the portion of the video frame based on the portion of the video frame being flat, and performing a final mode decision for the portion of the video frame based at least in part on an inter-prediction mode coding cost for the portion of the video frame associated with an initial motion vector and an initial inter-prediction partition choice for the portion of the video frame.

Further to the first embodiments, the method further comprises bypassing a transform size check for the portion of the video frame based on the portion of the video frame being flat and selecting a maximum transform size for the portion of the video frame based on the portion of the video frame being flat.

Further to the first embodiments, the method further comprises bypassing a transform size check for the portion of the video frame based on the portion of the video frame being flat and selecting a maximum transform size for the portion of the video frame based on the portion of the video frame being flat, wherein the maximum transform size comprises a size of the portion of the video frame.

Further to the first embodiments, the method further comprises bypassing a transform size check for the portion of the video frame based on the portion of the video frame being flat and selecting a maximum transform size for the portion of the video frame based on the portion of the video frame being flat, and/or wherein the maximum transform size comprises a size of the portion of the video frame.

Further to the first embodiments, the method further comprises determining a second portion of the video frame is not flat based on a second flatness check of the second portion of the video frame and selecting a minimum transform size for the second portion of the video frame based on the second portion of the video frame being not flat.

Further to the first embodiments, the method further comprises determining a second portion of the video frame is not flat based on a second flatness check of the second portion of the video frame, selecting a minimum transform size for the second portion of the video frame based on the second portion of the video frame being not flat, performing a second inter-prediction partition check for the second portion of the video frame based on the second portion of the video frame being not flat and based on a second initial motion vector and a second initial inter-prediction partition choice for the second portion of the video frame to determine a final motion vector and a final inter-prediction partition choice for the second portion of the video frame, and performing a second final mode decision for the second portion of the video frame based at least in part on a second inter-prediction mode coding cost for the second portion of the video frame associated with the final motion vector and the final inter-prediction partition choice for the second portion of the video frame.

Further to the first embodiments, the method further comprises determining a second portion of the video frame is not flat based on a second flatness check of the second portion of the video frame and selecting a minimum transform size for the second portion of the video frame based on the second portion of the video frame being not flat and/or performing a second inter-prediction partition check for the second portion of the video frame based on the second portion of the video frame being not flat and based on a second initial motion vector and a second initial inter-prediction partition choice for the second portion of the video frame to determine a final motion vector and a final inter-prediction partition choice for the second portion of the video frame and performing a second final mode decision for the second portion of the video frame based at least in part on a second inter-prediction mode coding cost for the second portion of the video frame associated with the final motion vector and the final inter-prediction partition choice for the second portion of the video frame.

Further to the first embodiments, the method further comprises determining a second portion of the video frame is not flat based on a second flatness check of the second portion of the video frame, determining the initial motion vector, the initial inter-prediction partition, and a second initial motion vector and a second initial inter-prediction partition for the second portion of the video frame based on a tree pruning technique, and performing a second inter-prediction partition check for the second portion of the video frame based on the portion of the video frame being not flat, the second inter-prediction partition check comprising a full partition options evaluation for the second portion of the video frame to generate a final motion vector and a final inter-prediction partition choice for the second portion of the video frame.

Further to the first embodiments, the flatness check comprises at least one of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold.

Further to the first embodiments, the final mode decision for the portion of the video frame is further based on an intra-prediction mode coding cost for the portion of the video frame and a skip mode coding cost for the portion of the video frame.

Further to the first embodiments, the portion of the video frame comprises at least one of a macroblock or a coding unit.

Further to the first embodiments, the final mode decision for the portion of the video frame is further based on an intra-prediction mode coding cost for the portion of the video frame and a skip mode coding cost for the portion of the video frame, and/or wherein the portion of the video frame comprises at least one of a macroblock or a coding unit.

Further to the first embodiments, the partition check comprises one or more calls to a hardware video motion estimation engine.

Further to the first embodiments, the method further comprises encoding the portion of the video frame based at least in part on the final mode decision to generate an encoded bitstream.

Further to the first embodiments, the method further comprises encoding the portion of the video frame based at least in part on the final mode decision to generate an encoded bitstream, and/or wherein the partition check comprises one or more calls to a hardware video motion estimation engine.

In one or more second embodiments, a system for providing a video encoding comprises a memory configured to store video data and a central processing unit coupled to the memory, wherein the central processing unit comprises flatness check circuitry to determine a portion of a video frame is flat based on a flatness check of the portion of the video frame, controller circuitry to bypass an inter-prediction partition check for the portion of the video frame based on the portion of the video frame being flat, and mode selection circuitry to perform a final mode decision for the portion of the video frame based at least in part on an inter-prediction mode coding cost for the portion of the video frame associated with an initial motion vector and an initial inter-prediction partition choice for the portion of the video frame.

Further to the second embodiments, the controller circuitry is to bypass a transform size check for the portion of the video frame based on the portion of the video frame being flat and to select a maximum transform size for the portion of the video frame based on the portion of the video frame being flat.

Further to the second embodiments, the controller circuitry is to bypass a transform size check for the portion of the video frame based on the portion of the video frame being flat and to select a maximum transform size for the portion of the video frame based on the portion of the video frame being flat, wherein the maximum transform size comprises a size of the portion of the video frame.

Further to the second embodiments, the flatness check circuitry is to determine a second portion of the video frame is not flat based on a second flatness check of the second portion of the video frame and the controller circuitry is to select a minimum transform size for the second portion of the video frame based on the second portion of the video frame being not flat.

Further to the second embodiments, the system further comprises inter-prediction circuitry to perform a second inter-prediction partition check for the second portion of the video frame based on the second portion of the video frame being not flat and based on a second initial motion vector and a second initial inter-prediction partition choice for the second portion of the video frame to determine a final motion vector and a final inter-prediction partition choice for the second portion of the video frame, wherein the mode selection circuitry is to perform a second final mode decision for the second portion of the video frame based at least in part on a second inter-prediction mode coding cost for the second portion of the video frame associated with the final motion vector and the final inter-prediction partition choice for the second portion of the video frame.

Further to the second embodiments, the flatness check circuitry is to determine a second portion of the video frame is not flat based on a second flatness check of the second portion of the video frame and the system further comprises inter-prediction circuitry to determine the initial motion vector, the initial inter-prediction partition, and a second initial motion vector and a second initial inter-prediction partition for the second portion of the video frame based on a tree pruning technique and to perform a second inter-prediction partition check for the second portion of the video frame based on the portion of the video frame being not flat, the second inter-prediction partition check comprising a full partition options evaluation for the second portion of the video frame to generate a final motion vector and a final inter-prediction partition choice for the second portion of the video frame.

Further to the second embodiments, the flatness check comprises at least one of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold.

Further to the second embodiments, the final mode decision for the portion of the video frame is further based on an intra-prediction mode coding cost for the portion of the video frame and a skip mode coding cost for the portion of the video frame.

Further to the second embodiments, the portion of the video frame comprises at least one of a macroblock or a coding unit.

Further to the second embodiments, the system further comprises a hardware video motion estimation engine to perform at least a portion of the partition check.

Further to the second embodiments, the flatness check comprises at least one of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold, and/or wherein the system further comprises a hardware video motion estimation engine to perform at least a portion of the partition check.

Further to the second embodiments, the system further comprises an entropy encoder to encode the portion of the video frame based at least in part on the final mode decision to generate an encoded bitstream.

In one or more third embodiments, a system for providing a video encoding comprises means for determining a portion of a video frame is flat based on a flatness check of the portion of the video frame, means for bypassing an inter-prediction partition check for the portion of the video frame based on the portion of the video frame being flat, and means for performing a final mode decision for the portion of the video frame based at least in part on an inter-prediction mode coding cost for the portion of the video frame associated with an initial motion vector and an initial inter-prediction partition choice for the portion of the video frame.

Further to the third embodiments, the system further comprises means for bypassing a transform size check for the portion of the video frame based on the portion of the video frame being flat and means for selecting a maximum transform size for the portion of the video frame based on the portion of the video frame being flat.

Further to the third embodiments, the system further comprises means for determining a second portion of the video frame is not flat based on a second flatness check of the second portion of the video frame and means for selecting a minimum transform size for the second portion of the video frame based on the second portion of the video frame being not flat.

Further to the third embodiments, the system further comprises means for determining a second portion of the video frame is not flat based on a second flatness check of the second portion of the video frame, means for selecting a minimum transform size for the second portion of the video frame based on the second portion of the video frame being not flat, means for performing a second inter-prediction partition check for the second portion of the video frame based on the second portion of the video frame being not flat and based on a second initial motion vector and a second initial inter-prediction partition choice for the second portion of the video frame to determine a final motion vector and a final inter-prediction partition choice for the second portion of the video frame, and means for performing a second final mode decision for the second portion of the video frame based at least in part on a second inter-prediction mode coding cost for the second portion of the video frame associated with the final motion vector and the final inter-prediction partition choice for the second portion of the video frame.

Further to the third embodiments, the system further comprises means for determining a second portion of the video frame is not flat based on a second flatness check of the second portion of the video frame, means for determining the initial motion vector, the initial inter-prediction partition, and a second initial motion vector and a second initial inter-prediction partition for the second portion of the video frame based on a tree pruning technique, and means for performing a second inter-prediction partition check for the second portion of the video frame based on the portion of the video frame being not flat, the second inter-prediction partition check comprising a full partition options evaluation for the second portion of the video frame to generate a final motion vector and a final inter-prediction partition choice for the second portion of the video frame.

Further to the third embodiments, the flatness check comprises at least one of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold.

Further to the third embodiments, the final mode decision for the portion of the video frame is further based on an intra-prediction mode coding cost for the portion of the video frame and a skip mode coding cost for the portion of the video frame.

In one or more fourth embodiments, at least one machine readable medium comprises a plurality of instructions that in response to being executed on a computing device, cause the computing device to encode video by determining a portion of a video frame is flat based on a flatness check of the portion of the video frame, bypassing an inter-prediction partition check for the portion of the video frame based on the portion of the video frame being flat, and performing a final mode decision for the portion of the video frame based at least in part on an inter-prediction mode coding cost for the portion of the video frame associated with an initial motion vector and an initial inter-prediction partition choice for the portion of the video frame.

Further to the fourth embodiments, the machine readable medium comprises further instructions that in response to being executed on a computing device, cause the computing device to encode video by bypassing a transform size check for the portion of the video frame based on the portion of the video frame being flat and selecting a maximum transform size for the portion of the video frame based on the portion of the video frame being flat.

Further to the fourth embodiments, the machine readable medium comprises further instructions that in response to being executed on a computing device, cause the computing device to encode video by determining a second portion of the video frame is not flat based on a second flatness check of the second portion of the video frame and selecting a minimum transform size for the second portion of the video frame based on the second portion of the video frame being not flat.

Further to the fourth embodiments, the machine readable medium comprises further instructions that in response to being executed on a computing device, cause the computing device to encode video by determining a second portion of the video frame is not flat based on a second flatness check of the second portion of the video frame, selecting a minimum transform size for the second portion of the video frame based on the second portion of the video frame being not flat, performing a second inter-prediction partition check for the second portion of the video frame based on the second portion of the video frame being not flat and based on a second initial motion vector and a second initial inter-prediction partition choice for the second portion of the video frame to determine a final motion vector and a final inter-prediction partition choice for the second portion of the video frame, and performing a second final mode decision for the second portion of the video frame based at least in part on a second inter-prediction mode coding cost for the second portion of the video frame associated with the final motion vector and the final inter-prediction partition choice for the second portion of the video frame.

Further to the fourth embodiments, the machine readable medium comprises further instructions that in response to being executed on a computing device, cause the computing device to encode video by determining a second portion of the video frame is not flat based on a second flatness check of the second portion of the video frame, determining the initial motion vector, the initial inter-prediction partition, and a second initial motion vector and a second initial inter-prediction partition for the second portion of the video frame based on a tree pruning technique, and performing a second inter-prediction partition check for the second portion of the video frame based on the portion of the video frame being not flat, the second inter-prediction partition check comprising a full partition options evaluation for the second portion of the video frame to generate a final motion vector and a final inter-prediction partition choice for the second portion of the video frame.

Further to the fourth embodiments, the flatness check comprises at least one of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold.

Further to the fourth embodiments, the machine readable medium comprises further instructions that in response to being executed on a computing device, cause the computing device to encode video by encoding the portion of the video frame based at least in part on the final mode decision to generate an encoded bitstream.

In one or more fifth embodiments, at least one machine readable medium may include a plurality of instructions that in response to being executed on a computing device, causes the computing device to perform a method according to any one of the above embodiments.

In one or more sixth embodiments, an apparatus may include means for performing a method according to any one of the above embodiments.

It will be recognized that the invention is not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the invention should, therefore, be determined with reference to the appended claims, along with the full scope of equivalents to which such claims are entitled.

What is claimed is:

1. A computer-implemented method for video coding comprising:
determining a portion of a video frame is flat based on a flatness check of the portion of the video frame;
bypassing an inter-prediction partition check for the portion of the video frame based on the portion of the video frame being flat; and
performing a final mode decision for the portion of the video frame based at least in part on an inter-prediction mode coding cost for the portion of the video frame associated with an initial motion vector and an initial inter-prediction partition choice for the portion of the video frame.

2. The method of claim 1, further comprising:
bypassing a transform size check for the portion of the video frame based on the portion of the video frame being flat; and
selecting a maximum transform size for the portion of the video frame based on the portion of the video frame being flat.

3. The method of claim 2, wherein the maximum transform size comprises a size of the portion of the video frame.

4. The method of claim 1, further comprising:
determining a second portion of the video frame is not flat based on a second flatness check of the second portion of the video frame; and
selecting a minimum transform size for the second portion of the video frame based on the second portion of the video frame being not flat.

5. The method of claim 4, further comprising:
performing a second inter-prediction partition check for the second portion of the video frame based on the second portion of the video frame being not flat and based on a second initial motion vector and a second initial inter-prediction partition choice for the second portion of the video frame to determine a final motion vector and a final inter-prediction partition choice for the second portion of the video frame; and
performing a second final mode decision for the second portion of the video frame based at least in part on a second inter-prediction mode coding cost for the second portion of the video frame associated with the final motion vector and the final inter-prediction partition choice for the second portion of the video frame.

6. The method of claim 1, further comprising:
determining a second portion of the video frame is not flat based on a second flatness check of the second portion of the video frame;
determining the initial motion vector, the initial inter-prediction partition, and a second initial motion vector and a second initial inter-prediction partition for the second portion of the video frame based on a tree pruning technique; and
performing a second inter-prediction partition check for the second portion of the video frame based on the portion of the video frame being not flat, the second inter-prediction partition check comprising a full partition options evaluation for the second portion of the video frame to generate a final motion vector and a final inter-prediction partition choice for the second portion of the video frame.

7. The method of claim 1, wherein the flatness check comprises at least one of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold.

8. The method of claim 1, wherein the final mode decision for the portion of the video frame is further based on an intra-prediction mode coding cost for the portion of the video frame and a skip mode coding cost for the portion of the video frame.

9. The method of claim 1, wherein the portion of the video frame comprises at least one of a macroblock or a coding unit.

10. The method of claim 1, wherein the partition check comprises one or more calls to a hardware video motion estimation engine.

11. The method of claim 1, further comprising:
encoding the portion of the video frame based at least in part on the final mode decision to generate an encoded bitstream.

12. A system for providing a video encoding comprising:
a memory configured to store video data; and
a central processing unit coupled to the memory, wherein the central processing unit comprises:
flatness check circuitry to determine a portion of a video frame is flat based on a flatness check of the portion of the video frame;
controller circuitry to bypass an inter-prediction partition check for the portion of the video frame based on the portion of the video frame being flat; and
mode selection circuitry to perform a final mode decision for the portion of the video frame based at least in part on an inter-prediction mode coding cost for the portion of the video frame associated with an initial motion vector and an initial inter-prediction partition choice for the portion of the video frame.

13. The system of claim 12, wherein the controller circuitry is to bypass a transform size check for the portion of the video frame based on the portion of the video frame being flat and to select a maximum transform size for the portion of the video frame based on the portion of the video frame being flat.

14. The system of claim 12, wherein the flatness check circuitry is to determine a second portion of the video frame is not flat based on a second flatness check of the second portion of the video frame and the controller circuitry is to select a minimum transform size for the second portion of the video frame based on the second portion of the video frame being not flat.

15. The system of claim 14, further comprising:
inter-prediction circuitry to perform a second inter-prediction partition check for the second portion of the video frame based on the second portion of the video frame being not flat and based on a second initial motion vector and a second initial inter-prediction partition choice for the second portion of the video frame to determine a final motion vector and a final inter-prediction partition choice for the second portion of the video frame,
wherein the mode selection circuitry is to perform a second final mode decision for the second portion of the video frame based at least in part on a second inter-prediction mode coding cost for the second portion of the video frame associated with the final motion vector and the final inter-prediction partition choice for the second portion of the video frame.

16. The system of claim 12, wherein the flatness check circuitry is to determine a second portion of the video frame is not flat based on a second flatness check of the second portion of the video frame, the system further comprising:
inter-prediction circuitry to determine the initial motion vector, the initial inter-prediction partition, and a second initial motion vector and a second initial inter-prediction partition for the second portion of the video frame based on a tree pruning technique and to perform a second inter-prediction partition check for the second portion of the video frame based on the portion of the video frame being not flat, the second inter-prediction partition check comprising a full partition options evaluation for the second portion of the video frame to generate a final motion vector and a final inter-prediction partition choice for the second portion of the video frame.

17. The system of claim 12, wherein the flatness check comprises at least one of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold.

18. The system of claim 12, further comprising:
a hardware video motion estimation engine to perform at least a portion of the partition check.

19. At least one machine readable medium comprising a plurality of instructions that in response to being executed on a computing device, cause the computing device to encode video by:
determining a portion of a video frame is flat based on a flatness check of the portion of the video frame;
bypassing an inter-prediction partition check for the portion of the video frame based on the portion of the video frame being flat; and
performing a final mode decision for the portion of the video frame based at least in part on an inter-prediction mode coding cost for the portion of the video frame associated with an initial motion vector and an initial inter-prediction partition choice for the portion of the video frame.

20. The machine readable medium of claim 19, the machine readable medium comprising further instructions that in response to being executed on a computing device, cause the computing device to encode video by:
bypassing a transform size check for the portion of the video frame based on the portion of the video frame being flat; and
selecting a maximum transform size for the portion of the video frame based on the portion of the video frame being flat.

21. The machine readable medium of claim 19, the machine readable medium comprising further instructions that in response to being executed on a computing device, cause the computing device to encode video by:
determining a second portion of the video frame is not flat based on a second flatness check of the second portion of the video frame; and
selecting a minimum transform size for the second portion of the video frame based on the second portion of the video frame being not flat.

22. The machine readable medium of claim 21, the machine readable medium comprising further instructions that in response to being executed on a computing device, cause the computing device to encode video by:
performing a second inter-prediction partition check for the second portion of the video frame based on the second portion of the video frame being not flat and based on a second initial motion vector and a second initial inter-prediction partition choice for the second portion of the video frame to determine a final motion vector and a final inter-prediction partition choice for the second portion of the video frame; and
performing a second final mode decision for the second portion of the video frame based at least in part on a second inter-prediction mode coding cost for the second portion of the video frame associated with the final motion vector and the final inter-prediction partition choice for the second portion of the video frame.

23. The machine readable medium of claim 19, the machine readable medium comprising further instructions that in response to being executed on a computing device, cause the computing device to encode video by:
determining a second portion of the video frame is not flat based on a second flatness check of the second portion of the video frame;
determining the initial motion vector, the initial inter-prediction partition, and a second initial motion vector and a second initial inter-prediction partition for the second portion of the video frame based on a tree pruning technique; and
performing a second inter-prediction partition check for the second portion of the video frame based on the portion of the video frame being not flat, the second inter-prediction partition check comprising a full partition options evaluation for the second portion of the video frame to generate a final motion vector and a final inter-prediction partition choice for the second portion of the video frame.

24. The machine readable medium of claim 19, wherein the flatness check comprises at least one of a comparison of a pixel variance of the portion of the video frame to a first threshold, a determination of whether all pixel values of the portion of the video frame are within a second threshold of an average of the pixel values of the portion of the video frame, or a comparison of a range of the pixel values to a third threshold.

25. The machine readable medium of claim 19, the machine readable medium comprising further instructions that in response to being executed on a computing device, cause the computing device to encode video by:
encoding the portion of the video frame based at least in part on the final mode decision to generate an encoded bitstream.
